(19) United States
(12) Patent Application Publication
(10) Pub. No.: US 2020/0083495 A1
(43) Pub. Date: Mar. 12, 2020

(54) THERMALLY PROTECTED FIBER BASED PRODUCTS

(71) Applicant: Motus Integrated Technologies, Holland, MI (US)

(72) Inventors: Jonathan Berghammer, Marion, NC (US); Karl David Snyder, Macomb, MI (US); John Joseph Todd, Farmington Hills, MI (US)

(21) Appl. No.: 16/567,371

(22) Filed: Sep. 11, 2019

Related U.S. Application Data
(60) Provisional application No. 62/729,586, filed on Sep. 11, 2018.

(51) Int. Cl. H01M 2/04; B32B 5/26; H01M 10/658

(52) U.S. Cl. CPC H01M 2/0482; B32B 5/26; H01M 10/658; B32B 2457/10; B32B 2307/304; H01M 2220/20; B32B 2605/00; B32B 2262/0223

(57) ABSTRACT

A fiber material assembly has a base fiber material disposed at least partly behind a oxidized polyacrylonitrile (PAN) fiber material that is secured to at least one side of the base fiber base material. The fiber material assembly provides a high thermal resistance via a low area weight usage of oxidized PAN fibers which overlie a base fiber material. The fiber material assembly can be provided such that the oxidized PAN fiber material provides either full or localized coverage, on one side or both sides, of the underlying base fiber material. The fiber material assembly provides the functionality of an acoustic heat shield or structural part with high thermal capacity.

### CROSS REFERENCE TO RELATED APPLICATION

The present application claims priority to and the benefit of U.S. Provisional Patent Application No. 62/729,586, entitled “THERMALLY PROTECTED FIBER BASED PRODUCTS”, filed Sep. 11, 2018, which is hereby incorporated by reference in its entirety.

### FIELD

The present disclosure is directed to a temperature resistant fiber or textile material and product as well as to a system and method of making fiber or textile-based products possessing high thermal resistance. The present disclosure is more particularly directed to a system and method of making fiber or textile-based products possessing high thermal resistance that can take the form of a structural part and which can also provide acoustic shielding.

The present disclosure is directed to a system and method for producing fiber or textile based products that have high thermal resistance and can be constructed such that the resultant product can function as an acoustic heat shield or a structural part having a high thermal capacity. Such parts have various applications across various industries. One such application relates to automotive and transportation industries wherein such materials can include structures and materials that form portions of engine compartments, underbody, drivetrain, battery (both traditional and lithium-ion) covers and shrouds, fuel tank and exhaust heat treatments which, in addition to the thermal shielding performance, include acoustical benefits.

### BACKGROUND

In the automotive and transportation industries, preventing heat and noise transmission to occupants or operators of a vehicle during vehicle operation is a common challenge. The challenge of preventing undesirable heat transmission is not limited to shielding operators and occupants of vehicles, it extends to blocking heat generated during vehicle operation from being transmitted to other components and areas of the vehicle.

While much attention is given to the challenges of preventing heat and noise transmission to automotive vehicles, such as cars and light trucks, as well as commercial vehicles, such as semi tractors, and the like, these same challenges are faced in many other industries and applications. For example, similar heat and noise shielding challenges are faced in nearly every vehicle and transportation related industry, including in the aerospace industry, marine industry, and off-road vehicle industry, as well as in other industries, such as the power-generation industry, electrical power transmission industry, and the like.

Heat shields and heat shield systems have not only been used on cars, trucks, and semi tractors, but on other types of vehicles, including ATVs, UTVs, snowmobiles, motorcycles, and boats and other marine craft. Heat shields and heat shield systems have also been used in other applications and other types of equipment using internal combustion engines or employing a combustion process during operation, including generators, welders, boilers, industrial ovens, and the like. Heat shields and heat shield systems have been commonly used on internal combustion engine equipped vehicles and equipment where the desired form factor associated with the resultant vehicle or equipment renders heat transmitting components, such as the engine, crankcase, exhaust system, etc. disposed in close proximity to other components that may be sensitive to being exposed to heat associated with the operation of the underlying engine system—such as heat-sensitive electrical equipment, including electronic control units (ECUs), electronic control modules (ECMs), other electrical equipment equipped with processors, e.g., CPUs, sensors, and other heat-sensitive electrical components, central or electronic control or processing units (CPU's and ECU's), as well as other heat-sensitive areas, systems and components, like the fuel system, combustible or flammable components, as well as structures exposed to heat or in close proximity to where heat is generated during operation that are intended to be acted upon by a person, such as an operator, servicer, or the like.

Areas of considerable noise and heat, such as the engine compartment and exhaust systems, and the discrete components associated therewith, may include one or more heat shields (e.g., of many types, shapes, sizes, and thicknesses) to manage thermal loads via insulation, thereby blocking heat from transferring to one or more areas and/or blocking conduction that may otherwise transfer heat away from one or more areas or components to one or more different areas or components. Such shields are commonly provided as thin metal foils or panels that are offset relative to heat generating, propagating, or transmitting structures. However, such heat shields suffer from a variety of drawbacks.

Such heat shields are typically constructed and provided in a manner that negligibly consider the acoustic properties of the heat shield and/or communication of noises associated with implementation of the same. Many current heat shielding solutions include aluminum heat shields having foils as well as complex composite heat shields with different solutions for acoustic performance. Unfortunately, such approaches result in assemblies wherein the acoustic and thermal performance of the heat shield defines a weak link in the thermal stack-up for the resultant part/assembly. Further, such approaches also add weight, cost, and complexity to the formation and assembly of the resultant vehicle and/or the discrete subsystems.

Accordingly, there is a need for a thermally protective, lightweight and easily formable and workable material and method of forming such materials that are suitable for use as heat shields and/or other structural components or the like and which are usable across a variety of applications and industries.

### SUMMARY

The present disclosure describes a system and method of making a fiber heat shield assembly formed of a core or base fiber material and which is overlaid, at least in part, with an oxidized polyacrylonitrile (PAN) fiber material configured as a thermally protective scrim such that the resultant fiber heat shield assembly made with the oxidized PAN fiber material thermally protective scrum provides a lightweight, low density, or low area weight solution that advantageously also possesses desirable and/or improved acoustic properties. Oxidized PAN fibers used in heat shield assemblies of the present disclosure provide very good thermal conductivity while insulating a core or base fiber material product, and the oxidized PAN fiber material is acoustically beneficial as it is relatively porous compared to shields and shrouds composed of metal or metallic materials.

Its relatively high porosity results from the relatively low denier or measure of the fiber thickness, and the oxidized PAN fiber material in combination with the core fiber-based material produces a generally porous shield assembly that can more readily absorb and dissipate noise, sound and other acoustic signals. Further, since oxidized PAN fiber will not burn, even when exposed to the most extreme of conditions, shield assemblies formed to include an oxidized PAN fiber layer can be advantageously employed in areas of the vehicle proximate the exhaust systems structures, components of the fuel systems, or other areas where thermal shielding is desired. Such assemblies employing an oxidized PAN fiber layer also advantageously can be formed into functional and load supporting structures possessing thermal resistance and acoustic absorption.

Forming structures and/or shields from fiber materials rather than metal materials also provides advantages associated with the cost of forming such shielding components. That is, costs typically are reduced or at least maintained by replacing complex, multi-material solutions with an integrated shielding fiber scrim material having oxidized PAN fiber, such as an integrated thermally shielding fiber scrim material formed with an oxidized PAN fiber layer.

In many applications, the fiber scrim material can replace the area and weight of a core material for a particular part or assembly to keep the resultant part or assembly weight neutral or to reduce the weight to less than the part being replaced while improving the thermal protection performance of the shielding structure and/or underlying part/assembly. As an integrated solution, heat shields and/or discrete parts constructed according to the present disclosure to include an oxidized PAN fiber material can replace assemblies that include multiple numbers of discrete parts, including in situations that employ stand-alone heat shields and/or complicated composite material shields. Use of oxidized PAN fiber material in such assemblies not only can be used to produce such assemblies with more economical and lighter weight constructions but advantageously also imparts improved thermal shielding performance.

Another aspect of the present disclosure is directed to a structure or part, e.g., component, having an oxidized PAN fiber material that is mechanically or chemically bonded to a fiber-based core material. It is appreciated that oxidized PAN fiber material can be attached to and/or used to form one or more sides and/or surfaces of the resultant structure or part desiring thermal shielding, depending on the application, use, purpose or function of the structure or part. It is further appreciated that oxidized PAN fiber material can be attached to and/or used to form one or more sides and/or surfaces of such a resultant structure or part desiring thermal shielding at those sides and/or surfaces of the structure or part, but which also advantageously provides desired acoustic sound or noise reduction at or along one or more of the sides and/or surfaces to which oxidized PAN fiber material is attached or formed. In one embodiment, such sides and/or surfaces, as well as part of the structure or part which supports its shape or is load supporting, can be formed of oxidized PAN fiber, including in the form of an oxidized PAN fiber layered material assembly, at least part of which can be in the form of an oxidized PAN fiber felt layered material. It is further appreciated that an oxidized PAN fiber layered material, e.g., an oxidized PAN fiber felt layered material, can be provided in either of a full coverage configuration or a localized coverage configuration as determined by the intended application or desired thermal and/or acoustic performance of the result structure or part.

In one method and embodiment, a structure or component having a three-dimensional shape is made of a moldable material, which can be formed of a moldable fiber material, and has a layer of oxidized PAN fiber material applied thereto (e.g., by one of mechanical and chemical bonding) to form a moldable oxidized PAN fiber assembly, and the moldable oxidized PAN fiber assembly is three-dimensionally molded or formed into the three-dimensionally shaped structure or component. In another embodiment, a moldable material, such as a moldable fiber material, is molded into the three-dimensional shape of a structure, part or assembly, and a layer of oxidized PAN fiber material is applied thereto (e.g., by one of mechanical and chemical bonding) to form the finished three-dimensionally shaped structure, part or assembly.

These and various other features, advantages, and objects of the present disclosure will be made apparent from the following detailed description and any appended drawings.

### DRAWINGS

One or more embodiments of the disclosure are illustrated in the accompanying drawings in which like reference numerals represent like parts throughout and in which:

FIG. 1 is a top plan view of a heat shielding material assembly according to the present disclosure and having an oxidized PAN material that is secured to a portion of an underlying core or base fiber material;

FIG. 2 is a perspective view of the heat shielding material assembly shown in FIG. 1 with various discrete part or blanks for subsequent processing, such as molding, having been cut therefrom;

FIG. 3 a graphic representation of various views of the heat shielding material assembly as shown in FIG. 1, wherein the oxidized PAN material is disposed over the entirety of at least one side of the underlying fiber core material;

FIG. 4 is a graphic representation similar to FIG. 3 and shows various views of an embodiment of the present disclosure, wherein the oxidized PAN material is configured to overlie less than the entirety of at least one side of the underlying fiber core material; and

FIG. 5 is a graphic representation similar to FIGS. 3 and 4 and shows various views of an alternate embodiment of the disclosure, wherein the oxidized PAN material is disposed over the entirety of each of the opposite sides of the underlying fiber core material.

Before explaining one or more embodiments of the disclosure in detail, it is to be understood that the disclosure is not limited in its application to the details of construction and the arrangement of the components set forth in the following description or illustrated in any appended drawings. Other embodiments can be practiced or carried out in various ways. Also, it is to be understood that the phraseology and terminology employed herein is for the purpose of description and should not be regarded as limiting.

### DETAILED DESCRIPTION

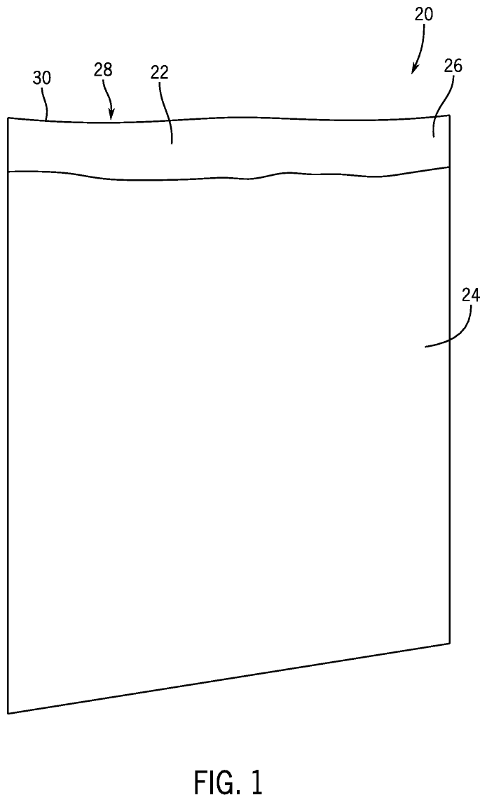

With reference to FIG. 1, the present disclosure is directed to remedying a long-standing problem in the construction and operation of engine powered machines such as automobiles, construction equipment, aerospace related technologies, recreational vehicles, other wheeled motor vehicles, trucks, semi-tractors, vans, ATV's, UTV's, motorcycles, or the like, as well as portable engine powered devices etc. wherein it is desired to provide thermal and/or acoustic isolation between respective discrete structures or systems thereof. Such equipment commonly includes elements that operate at elevated temperatures such as the engine, gear train, exhaust systems, etc. and other structures that can be impacted by exposure to the heat associated with the operation of such systems—such as the operator cabin, adjacent structures such as wiring harnesses, electronic control units, battery and battery systems, fuel tanks and lines, etc. It is readily appreciated that communication of heat and noise from one system to another can be detrimental to vehicle operation, longevity, and operator comfort.

As disclosed above, one or more heat shields are commonly provided between the hotter operating systems of the underlying vehicle and those structures that can be sensitive to heat or detract from operator comfort, for example. Commonly, vehicle construction includes a plurality of uniquely shaped heat shields that are defined by thin metal sheets that can provide both thermal and positional isolation between the discrete structures or systems associated therewith. As disclosed above, such shields suffer from various drawbacks including adding weight to the resultant vehicle or the subsystems thereof, do little to mitigate, and can occasionally contribute, to the noise associated with operation of the underlying vehicle. Further, such devices are generally expensive to produce and less than convenient to alter or manipulate to produce discrete heat shield or structural parts associated with the respective resultant assemblies.

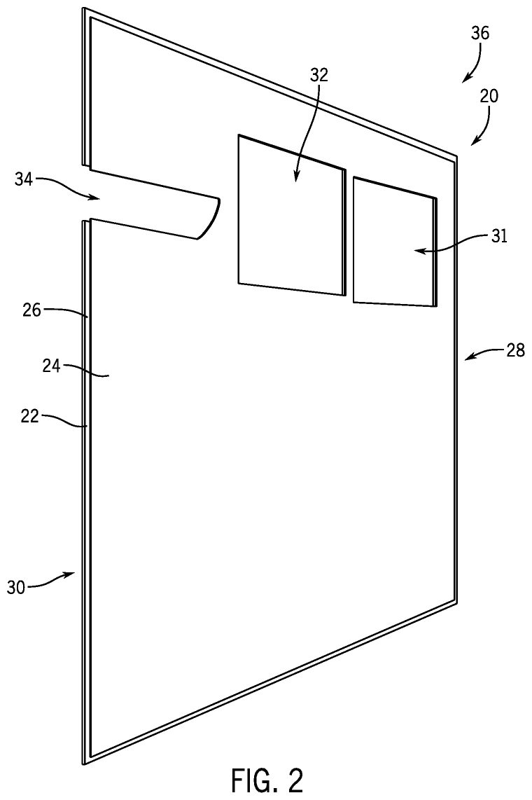

FIGS. 1 and 2 show a fiber shield assembly 20 according to the present disclosure and that is suitable for use in any or all of the various exemplary applications disclosed above. Referring to FIGS. 1 and 2, fiber shield assembly 20 is constructed to be useable in any vehicle environment where lightweight and superior thermal and acoustic properties are desired. Fiber shield assembly 20 includes a fiber base material 22 (e.g., moldable fiber base material) that at least partly underlies an oxidized polyacrylonitrile (PAN) fiber or fiber felt material 24. The fiber base material 22 may include natural and/or synthetic fibers. In addition, the oxidized PAN fiber material 24 provides a very low area weight heavy scrim type or strong, course fiber material formed of an oxidized polyacrylonitrile (OPAN) fiber which is a pure carbon fiber precursor material and which is bonded or otherwise adhered to the fiber base material 22, as disclosed further below. It is further envisioned that oxidized PAN fiber material 24 can be provided in various constructions including both fiber and non-fiber based methodologies to provide the desired thermal conductivity and acoustical properties as disclosed further below.

Fiber shield assembly 20 provides improved thermal conductivity and flame retardant properties in a very light weight form factor and with improved acoustical dampening values as compared to metal panel shield assemblies common to the applications disclosed above. That is, fiber shield assembly 20 is suitable for use in at least those areas of vehicle construction wherein fiber products are currently being employed for their acoustic properties but include ancillary thermal treatments such as aluminum or other metallic and/or ceramic heat shield structures, and provides such functionality in a highly economical and convenient to implement methodology and that can be conveniently individualized for a given application and/or implementation.

In addition to the various applications disclosed above, it is envisioned that the fiber shield assembly 20 can be implemented to provide various shield structures customary in vehicle constructions including engine compartment or bay walls, underbody panels, tunnel insulators, battery compartment covers or protectors, fuel tank protectors, and exhaust area treatments for example. Understandably, the applications referenced above are merely exemplary and it is envisioned that fiber shield assembly 20 has various other applications wherein thermal or acoustic isolation is desired.

Referring to FIGS. 1-5, fiber base material 22 is defined by a first side 26 and a second side 28 that face in generally opposite directions relative to a boundary edge 30 of base material 22. Although fiber base material 22 can be formed of a number of fibrous materials, one such material is provided as Aerotex® material that is formed of cellulosic and synthetic fibers. Fiber base material 22 is selected to provide a desired structure, shape, and strength to the overall construction of fiber shield assembly 20.

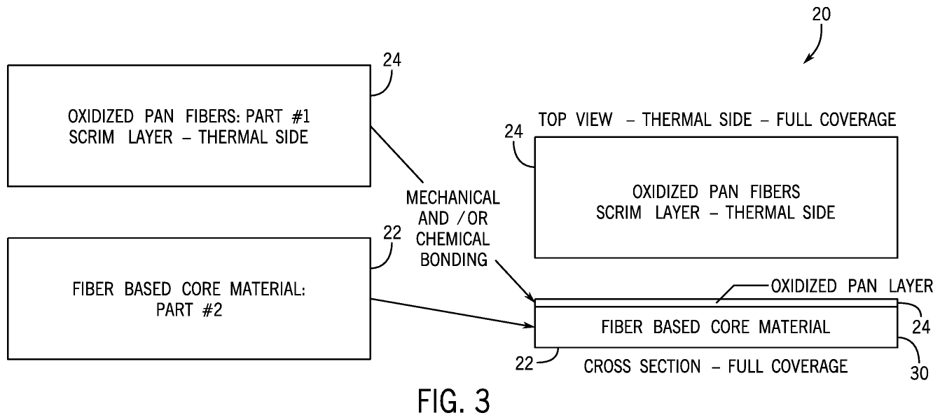

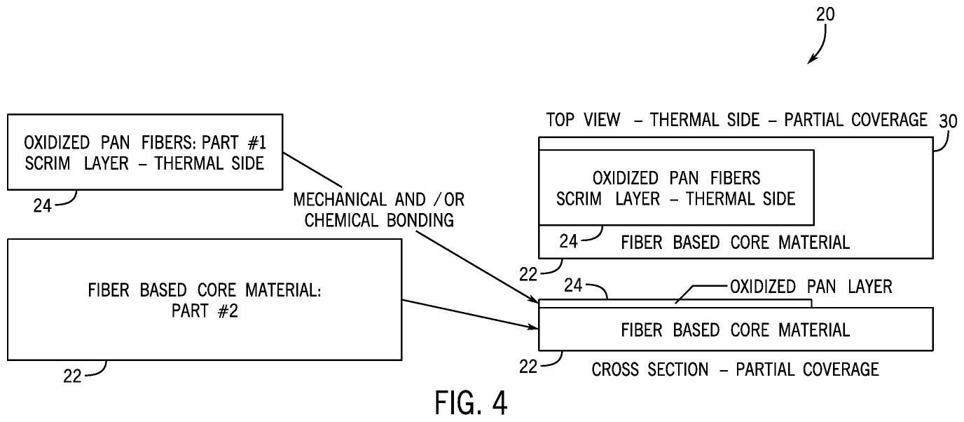

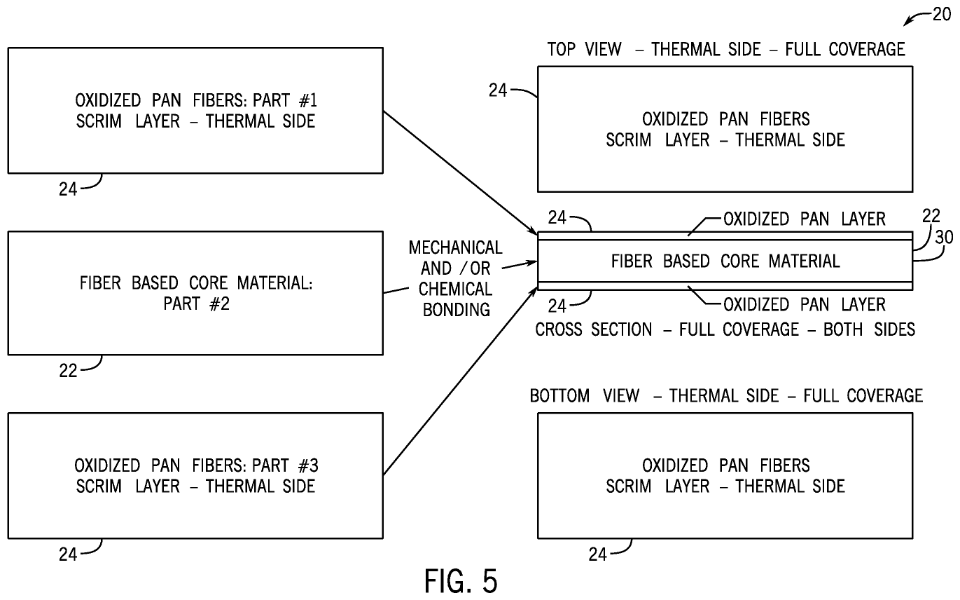

Oxidized PAN fiber material 24 overlies at least a portion of at least one of opposing sides 26, 28 of fiber base material 22. Referring to FIGS. 1 and 4, oxidized PAN fiber material 24 can be configured to extend over less than the entirety of one side 26, 28 of fiber base material 22. Alternatively, as shown in FIG. 3, oxidized PAN fiber material 24 can be configured to extend continuously over one side 26, 28 of fiber base material 22. Still further, referring to FIG. 5, oxidized PAN fiber material 24 can be configured to extend continuously over each of the opposite sides 26, 28 of fiber base material 22. Although not shown in the drawings, it is still further appreciated that each of opposite sides 26, 28 of fiber base material 22 could include respective layers of oxidized PAN fiber material 24 and that the respective layers of the oxidized PAN fiber material 24 may or may not be aligned with one another relative to directions normal to sides 26, 28 of base fiber material 22. Understandably, the placement and relative degree of coverage associated with the one or more respective layers of oxidized PAN fiber material 24 depends on the intended application and formation associated with use of the result shield assembly 20.

Regardless of the specific coverage associated with the one or more respective layers of oxidized PAN fiber material 24, the oxidized PAN fiber material 24 provides thermal conductivity and flame retardant properties to the one or more sides and one or more discrete locations associated with the core material to facilitate thermal protection when deployed or implemented. Oxidized PAN fiber material layer(s) 24 may be either mechanically secured or chemically bonded to the core or base fiber material 22. For example, oxidized PAN fiber material 24 may be mechanically secured to one or more of the discrete sides 26, 28, or one or more discrete locations, of base fiber material 22 prior to heating and molding of the fiber shield assembly 20 into a desired permanent shape or form factor associated with placement of the fiber shield assembly 20 relative to an underlying structure. As shown in FIG. 2, when mechanically secured to one another, various discrete form factors 31, 32, 34 can be conveniently removed from a bulk source 36 of fiber shield material 20. It should be appreciated that one or both sides 26, 28 of base fiber material 22 may be coupled to discrete layers or portions of oxidized PAN fiber material 24 depending on the intended application associated therewith.

Once a desired form factor 31, 32, 34 has been selected and/or removed from the bulk source 36, a molding process activates a binding material or other chemical bonding agent or applied web based adhesive associated with the generally planar interfaces between the base fiber material 22 and the overlying oxidized PAN fiber material 24 such that the discrete layers of the base fiber material 22 and oxidized PAN fiber material 24 are rendered inseparable from one another post molding processes absent physical destruction of the resultant fiber shield assembly 20.

Once formed and deployed in a desired form factor, the oxidized PAN fiber material 24 of the fiber shield assembly 20 reduces the transfer of heat from a heat source to the core or base fiber material 22, blocks heat transfer from a heat source to the core or base fiber material 22, or only allows the transfer of heat from a heat source to the core or base fiber material 22 at a level that protects the integrity of the base fiber material 22, while maintaining a desired resistance to overall air-flow to provide a desired acoustic value. When fiber shield assembly 20 is located near a heat source, the radiation, convection and conduction associated with the heat source is absorbed by the oxidized PAN fiber material 24 to provide the desired thermal conductive properties in a manner that limits exposure of the core or base fiber material 22 to the thermal energy, thereby allowing the core and overall construction of fiber shield assembly 20 to function within desired specifications associated with the structural rigidity, acoustic performance, and thermal exposure associated with use of the discrete fiber shield assembly 20.

A multiple layer fiber material shielding assembly 20 of the present disclosure is equipped with at least one surface of a fiber base layer material 22 wherein at least a portion of the at least one surface of the fiber base material 22 underlies an oxidized polyacrylonitrile (PAN) fiber material 24 that is secured thereto. The assembly 20 is mounted onboard or otherwise carried by a vehicle in a position or location where thermal or acoustic loads are intended to be isolated such that the shield or panel assembly 20 mitigates communication of the thermal or acoustic energy to other areas of the underlying vehicle. The fiber material assembly 20 provides a lightweight and robust heat shield or other structural element of the resultant vehicle. It is appreciated that a respective vehicle can be provided with a plurality of heat shields and/or structural elements constructed to the fiber material assembly 20 as disclosed herein.

Understandably, the present heat shielding fiber material assembly has been described above in terms of one or more embodiments and methods. It is recognized that various alternatives and modifications can be made to these embodiments and methods that are within the scope of the present disclosure. It is also to be understood that, although the foregoing description and drawings describe and illustrate in detail one or more embodiments of the present disclosure, to those skilled in the art to which the present disclosure relates, the present disclosure will suggest many modifications and constructions as well as widely differing embodiments and applications without thereby departing from the spirit and scope of the disclosure. The present disclosure, therefore, is intended to be limited only by the scope of the appended claims.

1. A heat shielding fiber material assembly comprising:
a moldable fiber base material, and
an oxidized polyacrylonitrile (PAN) fiber material secured to at least one side of the moldable fiber base material.

2. The heat shielding fiber material assembly of claim 1, wherein the heat shielding fiber material assembly is molded to form three-dimensionally contoured self-supporting structure.

3. The heat shielding fiber material assembly of claim 2, wherein the assembly is molded to form a battery cover and is structurally self-supporting.

4. The heat shielding fiber material assembly of claim 1, wherein the oxidized PAN fiber material is at least one of mechanically secured and chemically bonded to the moldable fiber base material.

5. The heat shielding fiber material assembly of claim 4, wherein the heat shielding fiber material assembly is molded to form a three-dimensionally contoured self-supporting structure.

6. The heat shielding fiber material assembly of claim 1, comprising another oxidized PAN fiber material that is secured to a side of the moldable fiber base material that is opposite the oxidized polyacrylonitrile (PAN) fiber material secured to the at least one side of the moldable fiber base material.

7. The heat shielding fiber material assembly of claim 6, wherein the heat shielding fiber material assembly is molded to form a three-dimensionally contoured self-supporting structure.

8. The heat shielding fiber material assembly of claim 1, wherein the heat shielding fiber material assembly is non-combustible.

9. A heat shielding fiber material assembly comprising:
a moldable fiber base material that has been molded into a three-dimensional shape, and
a layer of an oxidized polyacrylonitrile (PAN) fiber material secured to at least one side of the moldable fiber base material after the moldable fiber material has been molded into the three-dimensional shape.

10. The heat shielding fiber material assembly of claim 9, wherein the layer of oxidized PAN fiber material is at least one of mechanically secured and chemically bonded to the moldable fiber base material.

11. The heat shielding fiber material assembly of claim 10, comprising another layer of oxidized PAN fiber material secured to a different side of the moldable fiber base material after the moldable fiber base material has been molded into the three-dimensional shape.

12. The heat shielding fiber material assembly of claim 11, wherein the heat shielding fiber material assembly is molded to form a three-dimensionally contoured self-supporting structure.

13. The heat shielding fiber material assembly of claim 12, wherein the heat shielding fiber material assembly is molded to form a battery cover and is structurally self-supporting.

14. The heat shielding fiber material assembly of claim 13, wherein the heat shielding fiber material assembly is non-combustible.

15. A method of forming at least one of a structural part and a heat shield, the method comprising:
securing an oxidized polyacrylonitrile (PAN) fiber material to at least one side of a moldable fiber base material.

16. The method of claim 15, comprising molding the at least one of the structural part and the heat shield to have a contoured three dimensional shape.

17. The method of claim 15, wherein securing the oxidized PAN fiber material secured to the at least one side of the moldable fiber base material comprises at least one of mechanically securing and chemically bonding the oxidized polyacrylonitrile (PAN) fiber material to the at least one side of the moldable fiber base material.

18. The method of claim 17, comprising securing another oxidized PAN fiber material to a side of the moldable fiber base material that is opposite the at least one side of the moldable fiber base material.

19. The method of claim 15, comprising the molding the oxidized PAN fiber material that is secured to the at least one side of the moldable fiber base material to define at least one of a battery cover, an exhaust shroud, a vehicle fire wall, and a manifold shroud.

20. The method of claim 15, comprising cutting a desired shape from a bulk source of material of the oxidized PAN fiber material that is secured to at least one side of the moldable fiber base material.

21. The method of claim 15, comprising providing the oxidized PAN fiber material that is secured to at least one side of the moldable fiber base material such that the oxidized PAN fiber material extends over the entirety of the at least one side of the moldable fiber base material.
